(19) United States
(12) Patent Application Publication
(10) Pub. No.: US 2025/0095005 A1
(43) Pub. Date: Mar. 20, 2025

(54) Artificial Intelligence System-to-Client System User Interface Integration and Activated Telecommunication Plan Generation

(71) Applicant: Totogi Inc., Austin, TX (US)

(72) Inventors: Danielle Royston, Austin, TX (US); Marc Breslow, Westfield, NJ (US); Derya Yurt, Istanbul (TR); Harsh Arya, Jaipur (IN); Rishabh Raizada, Delhi (IN); Rahul Subramaniam, Chennai (IN)

(73) Assignee: Totogi Inc., Austin, TX (US)

(21) Appl. No.: 18/599,101

(22) Filed: Mar. 7, 2024

Related U.S. Application Data
(60) Provisional application No. 63/583,830, filed on Sep. 19, 2023.

(51) Int. Cl. G06Q 30/0201; H04W 16/18

(52) U.S. Cl. CPC G06Q 30/0201; H04W 16/18

(57) ABSTRACT

An artificial intelligence (AI) natural language processor (NLP) and telco plan generation environment includes an AI NLP telco plan generation system communicates with a telco planner client computer system via a specialized user interface that integrates with an existing telco planner client computer system user interface. The AI NLP telco plan generation system utilizes artificial intelligence including a natural language processor (NLP) to determine a telco planner's intent and generate proposed telco subscriber plans (telco plans). Integration of the client system-to-AI NLP telco plan generation system user interface between the telco planner client computer system AI NLP telco plan generation system improves computer technology by providing a specialized user interface that enables a telco planner to configure telco plan features, feature allowances, and thresholds and enter natural language telco plan generation requests and communicate the information to the AI NLP telco plan generation system.

### BACKGROUND OF THE INVENTION

### Field of the Invention

The present invention relates in general to the field of electronics, and more specifically to integrating a user interface between an artificial intelligence system and a client system to activate and utilize an artificial intelligence natural language processing system to generate telecommunication plans rapidly on-demand.

### Description of the Related Art

Mobile devices with telecommunication (telco) capabilities, such as smart phones, are used worldwide. In almost all instances, to utilize services of a telco network, a user of a mobile phone subscribes to a telco plan of a telco provider. Multiple telecommunication (telco) providers compete for subscribers by presenting one or more telco plans that each telco company believes will entice the most users to subscribe to plans offered by the telco company.

Conventionally, to develop a telco plan, a telco marketer comes up with an idea for a telco plan, and an information technology (IT) specialist familiar with a telco planning system manually configures a telco plan in accordance with the marketer's intent. The marketing person will then engage a content creator who will create different marketing creatives to be delivered via various communication channels, such as a short message service (SMS) text message and social media platforms.

Marketers typically will engage market research teams to find out what the competitors market share is, which are the areas where they have gaps within their plans. Once the research team collects the data, the research team engages a data scientist that puts data together in terms of trying to figure out how to approach gaps in their available telco plans, such as missing a balanced voice and data plan for a target segment in a specific target area. And then the marketer basically uses intuition to look at all the data and figure out how to bring that in.

However, conventional telco plan development is time consuming involves multiple personnel, human intuition based on long-term experience, and lacks technology to provide responsive telco plans in a fast changing, highly competitive market.

### SUMMARY

In one embodiment, a method includes providing a user interface to integrate communication between a telco planner client computer system and an artificial intelligence (AI) natural language processor (NLP) and telco plan generation system (AI NLP telco plan generation system) to:
(i) receive telco plan request representing a telco plan request, which includes a natural language telco plan request framework data; and
(ii) transmit to the AI NLP telco plan generation system, wherein the AI NLP telco plan generation system includes an artificial intelligence system having a natural language processing engine that includes a language model and machine learning algorithms;

The method further includes receiving, with the AI NLP telco plan generation system via the user interface, the natural language telco plan request framework data from the telco planner client computer system, wherein the natural language telco plan data includes data describing a telco plan desired by a user of the telco planner client computer system. The method also includes activating the AI NLP telco plan generation system to perform operations including:
a. determining and organizing metadata from the natural language telco plan data into a format that determines an intent of the machine-perceived user-intended telco plan, wherein the machine perceived user intended telco plan includes first telco plan features;
b. matching features of existing telco plans to the first telco plan features to identify competitive telco plans; and

The method additionally includes generating a proposed telco plan consistent with the machine perceived user intended telco plan having features and feature values that exceed the competitive telco plan features and feature values within defined constraints.

In one embodiment, an apparatus includes one or more processors and a memory, coupled to the one or more processors, that includes code that when executed causes the one or more processors to perform operations including:
providing a user interface to integrate communication between a telco planner client computer system and an artificial intelligence (AI) natural language processor (NLP) and telco plan generation system (AI NLP telco plan generation system) to:
   (i) receive telco plan request representing a telco plan request, which includes a natural language telco plan request framework data; and
   (ii) transmit to the AI NLP telco plan generation system, wherein the AI NLP telco plan generation system includes an artificial intelligence system having a natural language processing engine that includes a language model and machine learning algorithms;
receiving, with the AI NLP telco plan generation system via the user interface, the natural language telco plan request framework data from the telco planner client computer system, wherein the natural language telco plan data includes data describing a telco plan desired by a user of the telco planner client computer system;
activating the AI NLP telco plan generation system to perform operations comprising:
   a. determining and organizing metadata from the natural language telco plan data into a format that determines an intent of the machine-perceived user-intended telco plan, wherein the machine perceived user intended telco plan includes first telco plan features;
   b. matching features of existing telco plans to the first telco plan features to identify competitive telco plans; and
   c. generating a proposed telco plan consistent with the machine perceived user intended telco plan having features and feature values that exceed the competitive telco plan features and feature values within defined constraints.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary artificial intelligence (AI) natural language processor (NLP) telco plan generation environment.

FIG. 2 depicts an exemplary AI NLP telco plan generation process.

FIG. 3 depicts a telco plan generation process.

FIGS. 4-19 depict exemplary user interface displays presented by an integrated UI in response to information provided by an AI NLP and telco plan generator.

FIG. 20 depicts an exemplary network environment in which the system of FIG. 1 and the process of FIG. 2 may be practiced.

FIG. 21 depicts an exemplary specially programmed computer system.

### DETAILED DESCRIPTION

An artificial intelligence (AI) natural language processor (NLP) and telco plan generation environment includes an AI NLP telco plan generation system that communicates with a telco planner client computer system via a specialized user interface that integrates with an existing telco planner client computer system user interface. The AI NLP telco plan generation system utilizes artificial intelligence including a natural language processor (NLP) to determine a telco planner's intent and generate proposed telco subscriber plans (telco plans). Integration of the client system-to-AI NLP telco plan generation system user interface between the telco planner client computer system AI NLP telco plan generation system improves computer technology by providing a specialized user interface that enables a telco planner to configure telco plan features, feature allowances, and thresholds and enter natural language telco plan generation requests and communicate the information to the AI NLP telco plan generation system. In at least one embodiment, the natural language telco plan generation request is a framework for a telco plan. In at least one embodiment, telco plan generation request includes one or more objectives and/or requirements of a telco plan that provides sufficient information to determine an intent of a telco planner but does not include sufficient specific features and feature values to completely specify a telco plan.

The AI NLP telco plan generation system receives the natural language telco plan generation request as input data to process and generate a proposed telco plan. The AI NLP telco plan generation system processes the input data to determine an intent of the telco planner and to generate a proposed telco plan that provides features, feature subtypes, and allowance values that exceed competitive telco plan features, feature subtypes, and allowance values within defined constraints, such as commercial margin. By utilizing a natural language interface and determining an intent of a natural language submitted telco plan request, the AI NLP telco plan generation system provides improved technology to develop a proposed telco plan that not only complies with the framework, but the telco plan is also vetted to meet user-defined constraints. The telco plan is also superior to competitor telco plans by knowing the types of plans offered within a target market and which plans are good for that market in terms of, for example, target market and target segment preferences and profitability. In at least one embodiment, the AI NLP telco plan generation system utilizes artificial intelligence technology and access to an immense amount of data including a tremendous number of competing telco plans within a tremendous number of target segments and target locations that are not reasonable for a human to access and process within a reasonable amount of time. Utilization of the artificial intelligence technology replaces human intuition and specialized knowledge of telco plan configuration tools to rapidly generate the proposed telco plan that meets the intent of the telco planner. Human counterparts cannot reasonably review each and every competitive plan to understand the market. Thus, the telco plans humans develop are based on human intuition and experience developed across years of working in the same job. In at least one embodiment and as discussed previously, the AI NLP telco plan generation system replaces human intuition with artificial intelligence insights to understand a telco planner's intent and the competitive market landscape of telco plans and telco subscribers.

Thus, from a telco planner perspective, the telco planner who uses the AI NLP telco plan generation system does not need telco plan generation knowledge apart from understanding the framework of a desired telco plan. The telco planner does not need to understand what telco plans are currently offered in the target market to a target segment, what is a good plan, what is a bad plan, whether a telco plan is plan profitable or not, or other telco plan specifics. If the telco planner provides insufficient information to determine the intent of the telco planner for the telco plan, in at least one embodiment, the AI NLP telco plan generation system provides specific prompts to solicit the missing information. Additionally, in at least one embodiment, the AI NLP telco plan generation system includes predesigned templates, telco request choices, market information generation, and other controls that activate the AI NLP telco plan generation system to perform designated tasks.

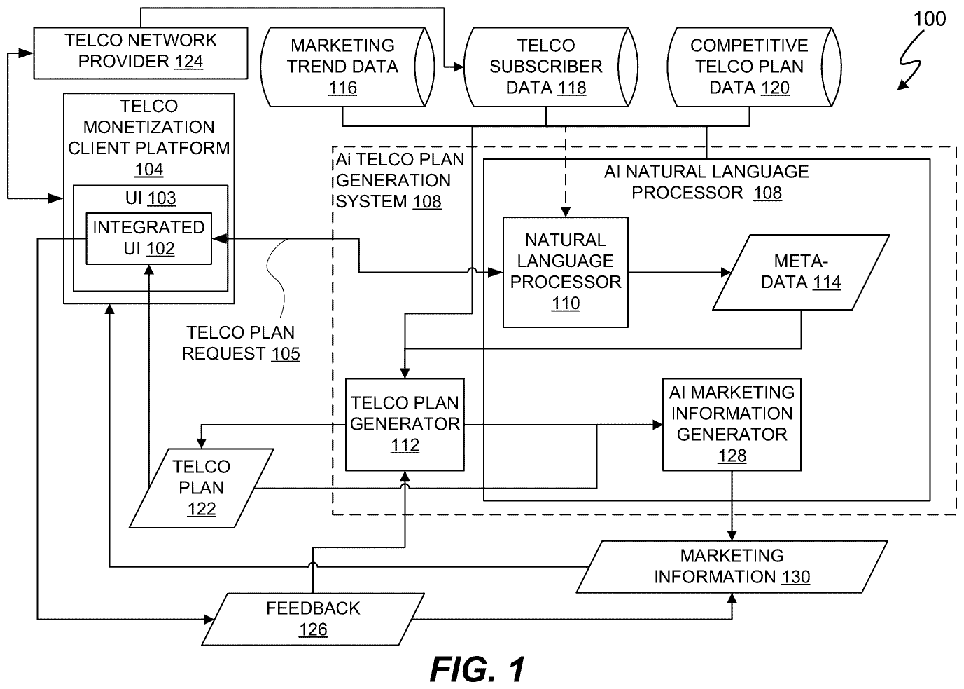

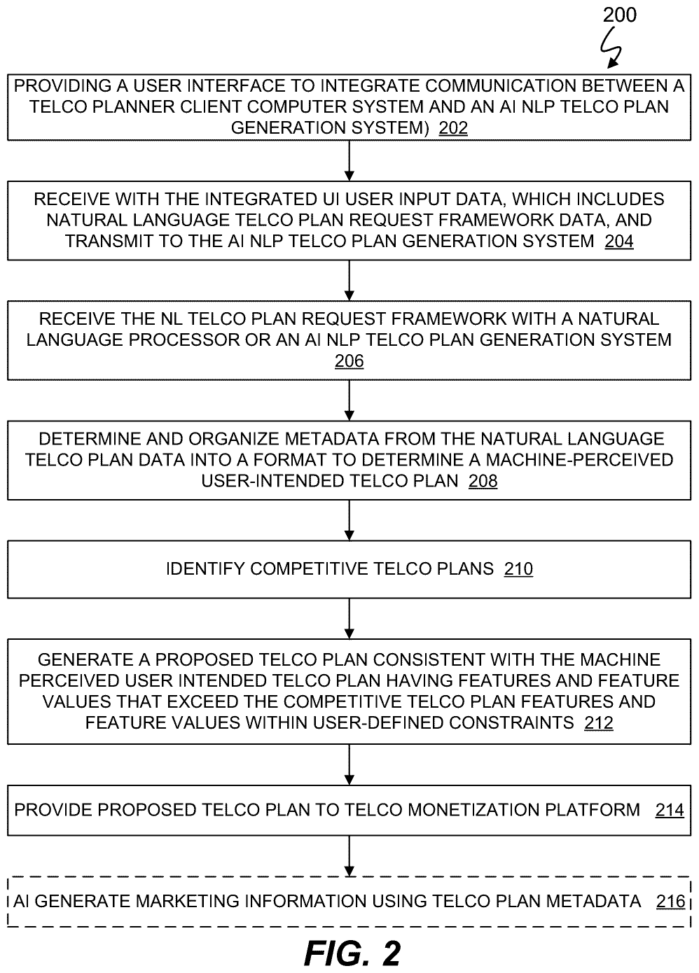

FIG. 1 depicts an exemplary AI NLP telco plan generation environment 100 to generate one or more proposed telco plans. FIG. 2 depicts an exemplary AI NLP telco plan generation process 200 utilized by AI NLP telco plan generation system 100. Referring to FIGS. 1 and 2, in operation 202, a user interface 102 is provided to the telco client monetization platform 104. The user interface 102 integrates with a telco monetization client platform user interface 103 using for example the Angular web telco planner client computer system framework or a browser extension, such as a Chrome extension. The integrated user interface 102 communicatively integrates the telco client platform 104, which represents one embodiment of a telco planner client computer system, and an AI NLP telco plan generation system 106. In at least one embodiment, the telco monetization platform 104 includes a client computer system that executes and/or accesses a telco monetization service program. The company Totogi of Austin, TX provides an exemplary telco client monetization client platform 102. In at least one embodiment, the AI NLP 108 is a chatbot.

In operation 204, the integrated UI 102 provides information and receives information to and from, the AI NLP 108 including the NL processor 110. The UI 102 transmits and the NL processor 110 receives a telco plan request from a telco planner using the telco client monetization platform 104. The telco plan request is a natural language request that, in at least one embodiment, is a query describing the telco plan that a user of the telco client monetization platform 104 would like created. In at least one embodiment and as previously mentioned, the natural language telco plan generation request 105 that includes one or more objectives and/or requirements of a telco plan, which provide sufficient intent for a telco plan but does not include or does not itself include sufficient specific features and feature values to completely specify a telco plan. “Create a Telco plan for youngsters of 18-24 age group who mostly use data” represents an exemplary natural language telco plan generation request 105 with a target segment of ages 18-24 that is data centric relative to voice calling. However, the request 105 is clearly not a telco plan because, for example, there is no pricing, no specific data quantity or bit rate allowances, no voice call allowances, or other features included in a telco plan as subsequently discussed in more detail.

In operation 206, the natural language processor 110 receives the natural language telco plan request framework data 105. An exemplary NL processor 110 is the GPT large language model (LLM) and framework for generative artificial intelligence available from OpenAI having an office in San Francisco, CA. In operation 208, once the natural language processor 110 determines an intent of the request 105 as described previously, the natural language processor 110 in operation 208 can organize the parsed the natural language telco plan request framework data 105 to determine metadata 114 and utilize the metadata to populate values for feature subtypes, allowances, and priorities. In at least one embodiment, the NL processor 110 organizes the metadata 112 into a programmitized, i.e., machine readable/useable format, such as JavaScript Object Notation (JSON) format. As described in more detail below, the metadata 112 is organized to include, for example, features, feature subtypes, allowances, and plan details of a telco plan 116 that will be responsive to the telco plan request 105 and included in the proposed telco plan with subsequently determined values. The particular information such as features and feature sub-types included in the metadata 112 are a matter of design choice to correlate with the telco planner's intent. The features and feature sub-types and can be programmatically revised and are, in at least one embodiment, determined based on the features to be included in the proposed telco plan 116 and plan details and objectives pertinent to the proposed telco plan 116. Exemplary plan detail features in the metadata 114 are:
a. Plan_name: The name of the plan.
b. Payment_type: The payment type for the plan-prepaid or postpaid.
c. Purchase_fec: Cost for the plan.
d. Renewal_fec: Renewal cost of the plan.

To determine the intent of the request 105, the natural language processor 110 utilizes artificial intelligence to parse the telco plan request 105. The AI NLP 108 is able to determine the planner's intent as predominately data usage with a price affordable based on specifying that the telco plan is for 18-24 years old people. In at least one embodiment, in operation 208 the NL processor 110 determines telco plan relevant metadata 114 from the telco plan request 105 and organizes the metadata into telco plan components that include plan details, features, and sub-types. In at least one embodiment, the NL processor 10 initially leaves allowance values and priority of the features and feature subtypes empty until competitive data is correlated and compared to the metadata. Exemplary features of the metadata 114 are Voice, Text, and Data. Exemplary feature subtypes of the metadata 114 for the Voice feature are voice-on-net, voice-off-net, voice-all-net, voice-multi-country, voice-roaming, voice-international, and voice-family-and-friends. Exemplary feature subtypes of the metadata 114 for the Text feature are text-on-net, text-off-net, text-all-net, text-multi-country, text-roaming, text-international, and text-family-and-friends. Exemplary feature subtypes of the metadata 114 for the Data feature are data-roaming and data-content-type. In at least one embodiment, the data subtypes each have a priority and an allowance, and one or more feature subtypes have one or more subtypes with priorities and allowances for sub-subtype, and so on. The number of features and feature subtypes is a matter of design choice. In at least one embodiment, the NL processor 110 determines the format and structural details of the metadata 114. In at least one embodiment, the format and components of the metadata 114 are provided to the NL processor 110, and the NL processor 110 determines the metadata and assigns the metadata to specific precursor components and assigns values to one or more of the precursor components of the metadata 114.

Additionally, in at least one embodiment, the components of the metadata 114 are either fully, partially, or not predetermined. Any predetermination of metadata 114 components provides known structure to the metadata 114 but full predetermination can also impinge on the flexibility and adaptability of the AI NLP 108.

The NL processor 110 has access to various data and data sources, such as marketing trend data 116, telco subscriber data 118, and competitive data 120. In these embodiments, the NL processor 110 is programmed to identify telco plan components from marketing, customer, and/or competitive data that are relevant to the request 105 and generate metadata 114 with the identified components.

Thus, in at least one embodiment, the NL processor 110 provides at least two functions. Determination of the telco planner's intent and determination and organization of the metadata 114 provides in a programmatic format a machine-perceived, user-intended telco plan framework representing an understanding of what a user of the telco monetization client platform 104 has asked, such as “Create a Telco plan for youngsters of 18-24 age group who mostly use data.” Another optional function of the NL processor 110 is utilizing artificial intelligence to identify features, feature subtypes, allowances, and priority such as the target segment and other features and feature subtypes of the telco plan 116 based on information obtained from one or more of the data sources 116-120. For example, adults 18-24 years of age generally have a lower average income, which indicates an expected amount that that particular target segment is generally willing to spend on telco plans.

As described in more detail below, in operation 210, the telco plan generator 112 receives the metadata 114 and determines whether the metadata 114 includes sufficient information to generate proposed telco plan 116. If the information is insufficient, the telco plan generator 112 requests additional information from the telco client monetization platform. If the metadata 114 is sufficient to generate proposed telco plan 116, the telco plan generator 112 identifies telco plans that are competitive to the proposed machine-perceived, user-intended telco plan by accessing the competitive telco plan data 120 and matches features of the machine-perceived, user-intended telco plan with competitive plans having the same or equivalent features or features within a predetermined range of allowance values. In at least one embodiment, features of the machine-perceived, user-intended telco plan and features of the competitive data 120 are normalized to facilitate obtaining exact matches or non-matches. In at least one embodiment, the telco plan generator 112 includes filters to determine matching plans such as excluding particular competitor plans, matching payment type to include both prepaid and postpaid plans, only match plans between a certain price range, such as a subscription price ±30% to ensure the telco plan generator 112 does not offer too high or too low features and allowances for this subscription price.

The below JSON file represents exemplary metadata for telco plan 122 based on a natural language telco plan request 105 of “Create a Telco plan for youngsters of 18-24 age group who mostly use data”:

```
{
  “category”: “revenue_growth”,
  “target_audience”: “youngsters”,
  “segment_type”: “moderate_income”,
  “expected_income”: 30000,
  “expected_expenditure_on_telco”: 5000,
  “content_types”: [
    “Whatsapp”,
    “Netflix”,
    “Spotify”,
    “Facebook”
  ],
  “plan_details”: {
    “plan_name”: “Youth Data Plan”,
    “payment_type”: “prepaid”,
    “purchase_fee”: 20.00,
    “renewal_fee”: 15.00
  },
  “features”: {
    “voice-on-net”: {
      “priority”: “low”,
      “allowance”: “zero”
    },
    “voice-off-net”: {
      “priority”: “low”,
      “allowance”: “zero”
    },
    “voice-all-net”: {
      “priority”: “low”,
      “allowance”: “zero”
    },
    “voice-multi-country”: {
      “priority”: “low”,
      “allowance”: “zero”,
      “from”: [ ],
      “to”: [ ]
    },
    “voice-roaming”: {
      “priority”: “low”,
      “allowance”: “zero”
    },
    “voice-international”: {
      “priority”: “low”,
      “allowance”: “zero”
    },
    “voice-family-and-friends”: {
      “priority”: “low”,
      “allowance”: “zero”
    },
    “text-on-net”: {
      “priority”: “low”,
      “allowance”: “zero”
    },
    “text-off-net”: {
      “priority”: “low”,
      “allowance”: “zero”
    },
    “text-all-net”: {
      “priority”: “low”,
      “allowance”: “zero”
    },
    “text-multi-country”: {
      “priority”: “low”,
      “allowance”: “zero”,
      “from”: [ ],
      “to”: [ ]
    },
    “text-roaming”: {
      “priority”: “low”,
      “allowance”: “zero”
    },
    “text-international”: {
      “priority”: “low”,
      “allowance”: “zero”
    },
    “text-family-and-friends”: {
      “priority”: “low”,
      “allowance”: “zero”
    },
    “data”: {
      “priority”: “high”,
      “allowance”: “unlimited”
    },
    “data-roaming”: {
      “priority”: “low”,
      “allowance”: “zero”
    },
    “data-content-type”: [
      {
        “priority”: “high”,
        “allowance”: “moderate”,
        “type”: “Whatsapp”
      },
      {
        “priority”: “high”,
        “allowance”: “high”,
        “type”: “Netflix”
      },
      {
        “priority”: “high”,
        “allowance”: “moderate”,
        “type”: “Spotify”
      },
      {
        “priority”: “low”,
        “allowance”: “low”,
        “type”: “Facebook”
      }
    ]
  }
}
```

In operation 212 the telco plan generator 112 generates the telco plan 122 consistent with the machine-perceived, user-intended telco plan having features and feature values that exceed competitive telco plan features and feature values within defined constraints to generate a maximum feature telco plan 122 within constraints such as cost and profit margin. The telco plan generator 112 then computes the price of the plan based on the metadata values. In at least one embodiment, if the maximum feature telco plan 122 is outside of the constraints, allowances may need to be reduced, features may need to be reduced, or a combination of allowance and feature reductions to meet a commercially viable threshold, which in at least one embodiment are stored in the teleco subscriber data 118. In at least one embodiment, to modify the maximum feature telco plan 122 to meet constraints the telco plan generator 112 iterates over retrieved competitive plans for a particular target location, such as a country target segment from the competitive telco plan database 120 having a price less than, for example, 130% of the price for features in the JSON formatted metadata. All these plans can have some or all of the feature_subtypes, therefore, for each subtype, the telco plan generator 112 iterates through the plans to create a list of all the possible features, feature subtypes, and allowances, then removes duplicates and sorts in ascending order. In at least one embodiment, the telco plan generator 112 first step assign the highest allowance, i.e., the last element in the list of all the possible allowances, for each feature_subtype to our max_feature plan.

Thus, in operation 212, if the max_feature telco plan requires reducing allowances or reducing features to make the teleco plan commercially viable, the telco plan generator 112 starts by lowering the features by decrementing an index to an allowance for each feature_subtype in the list and checking the commercial margin at each step. In at least one embodiment, the telco generator 112 provides one or more prompts, as for example shown in FIG. 1202 to allow the telco planner to determine which feature subtype allowances can be revised to meet the commercial margin threshold or any other threshold set up the telco planner. The telco plan generator 112 first iterates for all the low priority features, then moderate, and at last high priority as indicated in the metadata. If the feature allowance is already lowered the lowest value and a constraint such as price still does not meet a price threshold, the telco plan generator 112 completely removes the feature from the telco plan 122. For example and referencing the foregoing metadata determined from the telco plan request 105 of “Create a Telco plan for youngsters of 18-24 age group who mostly use data,” if the AI NLP 108 fetches all telco plans from the competitive telco plan data 120 having a renewal fee<=140% of “renewal_fee” price, i.e, 21.00, the telco plan generator 112 identifies a low priority feature_subtype, for example, voice-all-net, and creates a list of all the allowances from each telco plan, e.g. [10, 500, 100, 20, 200, 100, unlimited, unlimited] minutes. The telco plan generator 112 then removes duplicates and sorts the list in ascending order: [10, 20, 100, 500, unlimited]. Since the renewal price is within the price constraint of less than equal to 21.00, the max_feature telco plan 116 will include a Voice feature, a voice-all-net sub-type, and an allowance of unlimited minutes. If the telco plan 116 renewal price was more than the renewal price constraint of 21.00, the telco plan generator 112 would index back to 500 minutes and determine the renewal price. If the renewal price is not met, the telco plan generator 112 could continue the process with the voice-all-net sub-type or iterate over other feature sub-types until a plan meeting the constraints is determined.

In some instances of operation 212, where a single feature causes a parameter, such as a commercial margin to be less than a predefined threshold, the telco plan generator 112 reduces the constraint, such as reducing the commercial margin threshold by 20%, so that all features and allowance values will be maximized. There are numerous permutations of operation 212 that focus on particular low priority feature subtypes, use more than three granulations of priority, such as prioritizing each subtype uniquely, of course prioritizing subtypes differently depending on the business objectives, and so on to arrive at a telco plan 116 that includes values that exceed the competitive telco plan features and feature values within defined constraints.

In at least one embodiment, the telco plan 122 is initially in a programmitized format, such as JSON. In this embodiment, the telco plan generator 112 sends the programmitized formatted telco plan 122 to NL processor 110, and the NL processor 110 converts the programmitized formatted telco plan 122 into a natural language plan 122.

In operation 214, the telco plan generator 112 provides the proposed natural language telco plan 122 to the telco client monetization platform 104 via the integrated UI 102. In at least one embodiment, the telco plan generator 112 provides the programmitized formatted telco plan 122 to telco client monetization platform 104, and the telco client monetization platform 104 or the telco network provider 124 converts the telco plan 122 into natural language for publication to subscribers and potential subscribers. In at least one embodiment, the telco monetization platform 104 is operated by an entity separate from a telco network provider 124, and the telco monetization platform 104 provides the proposed telco plan 122 to the telco network provider 124. In at least one embodiment, providing the proposed telco plan 122 automatically triggers a review and/or telco plan activation system and process of the telco network 124 to make the telco plan 122 available to the public. In at least one embodiment, if the telco plan 122 is not acceptable, the telco client monetization platform 104 provides feedback 126 to the telco plan generator 112 to modify the telco plan 122.

To increase subscriptions to the teleco plan 122, in optional operation 216, optional AI marketing information generator 128 generates marketing information 130 from features and allowances of the telco plan 122. The form of the marketing information 130 is a matter of design choice. For example, the marketing information 130 can have the form of marketing materials, marketing banners, marketing SMS messages, and other forms. Additionally, in at least one embodiment, the AI marketing information generator includes models that create multiple types and content for marketing information 130 from the same telco plan 122 such as ten marketing SMS scripts for the youth data plan. Thus, in at least one embodiment, the AI NLP telco plan generation system 100 provides a comprehensive technologically improved solution that assists end to end with generating and marketing a telco plan.

In at least one embodiment, the telco plan generator 112 analyzes the telco subscriber data 118 to determine or obtain existing telco plans offered or formerly offered by the telco network provider 124. The telco plan generator 112 can determine gaps in the telco plan offerings and propose plans to fill in the gaps. “Gaps” represent, for example, a lack of telco plans that optimally appeal to particular target population segments with particular features, such as high data rates and amounts and low voice minutes. Additionally, in at least one embodiment, the telco plan generator 112 can develop multiple telco plans to enhance adoption of one or more particular telco plans by utilizing techniques such as behavioral economics. For example, in at least one embodiment the telco plan generator 112 by offering free features when certain plans are subscribed to, offering decoy plans that make the other plans appear more attractive.

Conventionally, developing new telco plans is a long process that can potentially take months by requiring, as previously mentioned, human experience and intuition. However, proposing superior plans to subscribers and potential subscribers quickly can be crucial to maintain and gain market share and/or profitability. The AI NLP telco plan generation system 100 provides improved technology to rapidly develop, market, and deploy new telco plans.

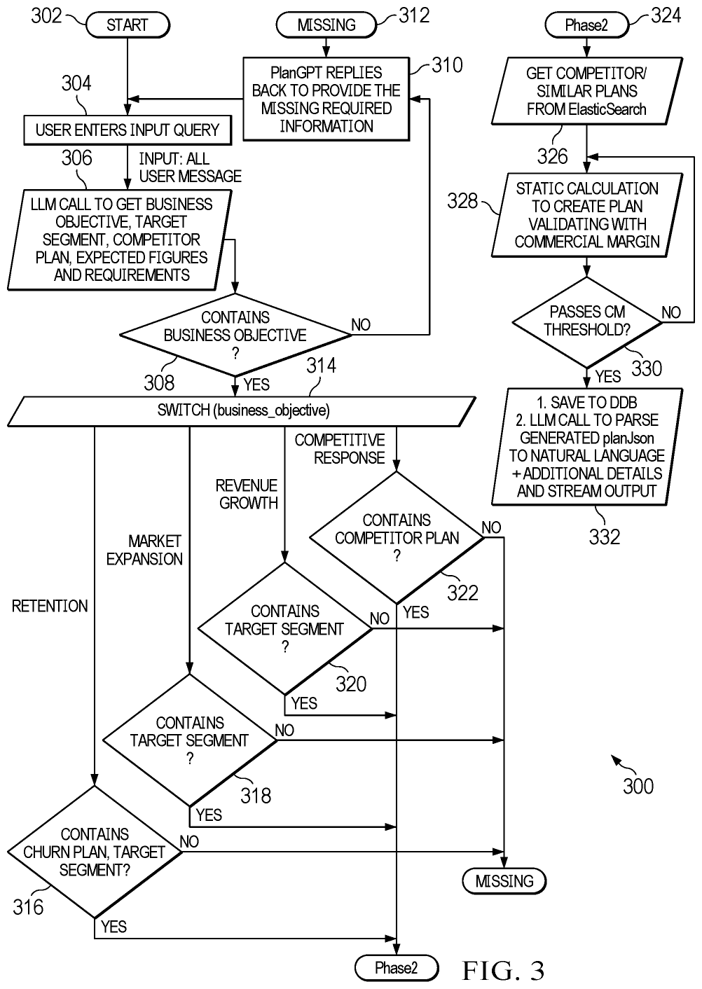

FIG. 3 depicts a telco plan generation process 300 utilized by an embodiment of the telco plan generator 112 to generate the telco plan 116. The telco plan generation process 300 among other things ensures that sufficient data is present in the metadata 114 to generate a functional telco plan 116. In telco plan generation process 300, “LLM” in operation 306 refers to a large language model embodiment of a model used by NL processor 110, such the LLM of chatGPT. “PlanGPT” refers to a Generative Pre-trained Transformer (GPT) chatbot embodiment of AI NLP 108. “ElasticSearch” refers to competitive data, such as an embodiment of competitive telco plan data 322. Referring to FIGS. 1 and 3, the process 300 starts at node 302 and proceeds to operation 304. In operation 304, the AI NLP 108 receives a telco plan request 105. In operation 306, the NL processor 110 calls a large language model to parse the telco plan request 105 to determine the telco planner's intent for a telco plan. Once the intent is determined, the NL processor 110 determines and organizes the metadata 114 with plan details, features, feature sub-types, allowances, and priorities including a business objective, target segment, competitor plan, and expected figures and requirements. The “figures” refer to, for example, numerical plan detail features, and requirements include telco plan constraints. In operation 308, the telco plan generator 112 determines if the metadata 114 contains a business objective. The particular business objective is a matter of design choice. Exemplary business objectives are retention, market expansion, competitive response, and revenue growth. If the metadata 114 does not include a business objective, in operation 310 the exemplary AI NLP 108, PlanGPT will prompt the user of telco monetization client platform 104 via integrated UI 102 to provide the missing business objective as indicated by missing node 312. Operations 304, 306, and 308 then repeat to include the business objective in the metadata 114. With the metadata 114 including the business objective, operation 314 then proceeds down the path that matches the business objective and ensures that the relevant plan details and data are present in the metadata 114. If the business objective is retention, operation 314 proceeds to operation 316, If the business objective is market expansion, operation 314 proceeds to operation 318. If the business objective is revenue growth, operation 314 proceeds to operation 320, and if the business objective is retention, operation 314 proceeds to operation 322. If operations 316, 318, 320, or 322 do not include a churn plan, target segment, target segment, target segment, or competitor plan, respectively, operations 304, 306, and 308 repeat to include the missing data in the metadata 114. When the churn plan, target segment, target segment, target segment, or competitor plan is included in metadata 114, process 300 begins phase 2 to generate the proposed telco plan 116.

In phase 2, operation 326, the AI NLP 108 embodiment PlanGPT retrieves competitor/similar telco plans from ElasticSearch using matching and filters as, for example, described with reference to operation 210 (FIG. 2). In operation 328, PlanGPT begins a static calculation to create a telco plan 116 that is validated against a commercial margin threshold by PlanGPT in operation 330. In at least one embodiment, operations 328 and 330 function in accordance with the description of operation 212. In operation 332, the generated telco plan 116 is saved as plan_json with JSON formatted metadata 114, and the NL processor 110 embodiment with the LLM utilizes reverse natural language processing to generate proposed telco plan 116 as a natural language version of the metadata 114 including an additional details such as the plan details. In operation 332, PlanGPT streams the proposed telco plan 116 to a destination, such as telco monetization client 104.

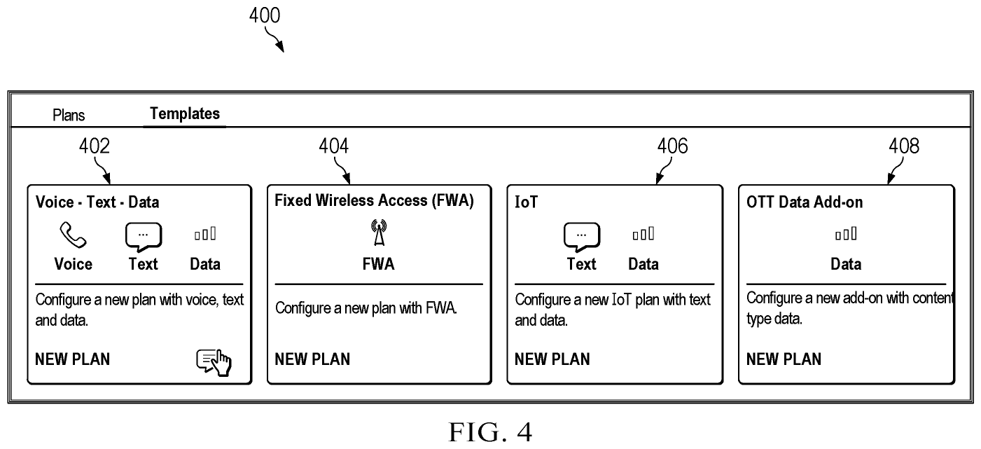

FIGS. 4-19 depict exemplary user interface displays presented by the integrated UI 102 in response to information provided by AI NLP 108 and telco plan generator 112. The exemplary user interface displays presented by the integrated UI 102 allow, in at least one embodiment, a telco planner using the telco client monetization platform 104 to submit telco plan requests so that the AI NLP 108 system operates as previously described to generate a telco plan that achieve that telco planner's intent. Additionally, FIGS. 4-19 depict and describe additional processes of providing information and telco plan requests to the AI NLP 108 by activating various controls provided by the integrated UI 102. Exemplary controls includes controls to activate generation of a specific request, generation of marketing information, and submission of natural language input data. The user interfaces of FIGS. 4-19, have data format on the left which is completed by a teleco planner. For example, a telco planner provide a natural language request 105 from which the AI NLP 108 can determine the telco planner's intent, but the telco planner does not require skill to create an entire telco plan, particularly a telco plan that superior to competitive plans by exceeding feature and feature subtype values. In at least one embodiment, “exceeding values” of a competitive telco plans means that at least one of the numerical characteristics of the telco plan 116 has obviously better value, such as more minutes, more data, lower costs, etc. However, not all feature and feature subtype values always exceed a competitive plan's values in order for telco plan 116 to be superior. For example, a competitive plan that provides a better value for a low priority feature is not superior if the telco plan 116 provides a better value for a high priority feature and all other values are equal or favor the telco plan 116. For example, providing more voice minutes to an 18 year old is not as valuable as providing more data by the telco plan 116. Once the telco plan 116 is completed, the telco plan can be quickly deployed by the telco network provider 124 and begin generating revenue.

FIG. 4 depicts an exemplary telco plan template display that includes template 402 to allow a telco planner using telco client monetization platform 104 to configure a new plan for generation of a Voice-Text-Data telco plan. Template 404 allows the telco planner to configure a new plan for generation of a Fixed Wireless Access telco plan. Template 406 allows the telco planner to configure a new plan for generation of an Internet of Things (IoT) for low data usage Text and Data telco plan, and template 308 allows the telco planner to configure a new plan for generation of an Over-the-Top (OTT) value added, Data Add-on with content type telco plan. The specific template types and objectives are a matter of design choice, and many others can be included as templates.

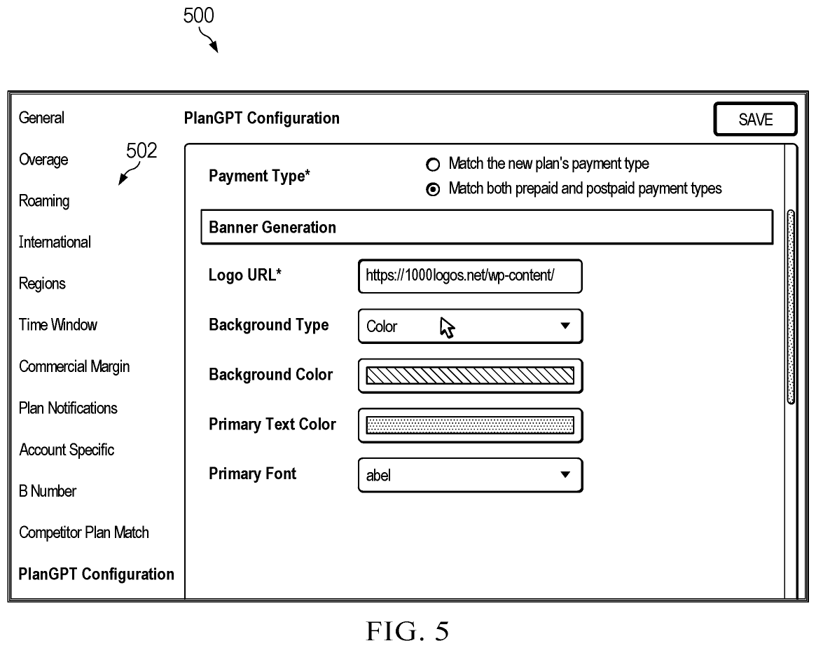

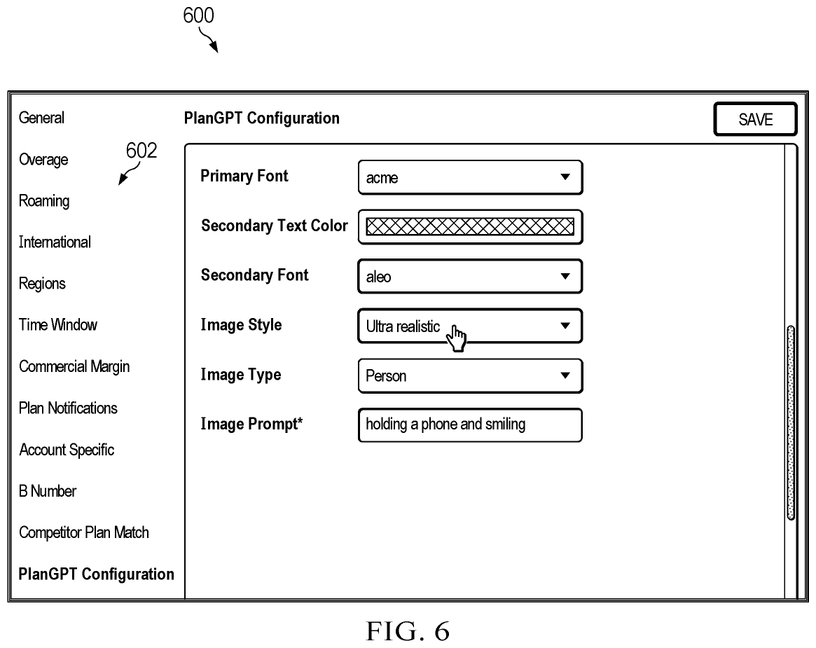

FIGS. 5 and 6 depict exemplary telco configuration UI's 500 and 600. The menus 502 and 602 allow a telco planner to configure the telco plan specifications identified in menus 502 and 602. UI's 500 and 600 representatively depict configuration of selected features of AI NLP 108 embodiment, PlanGPT including payment type and marketing banner presentation.

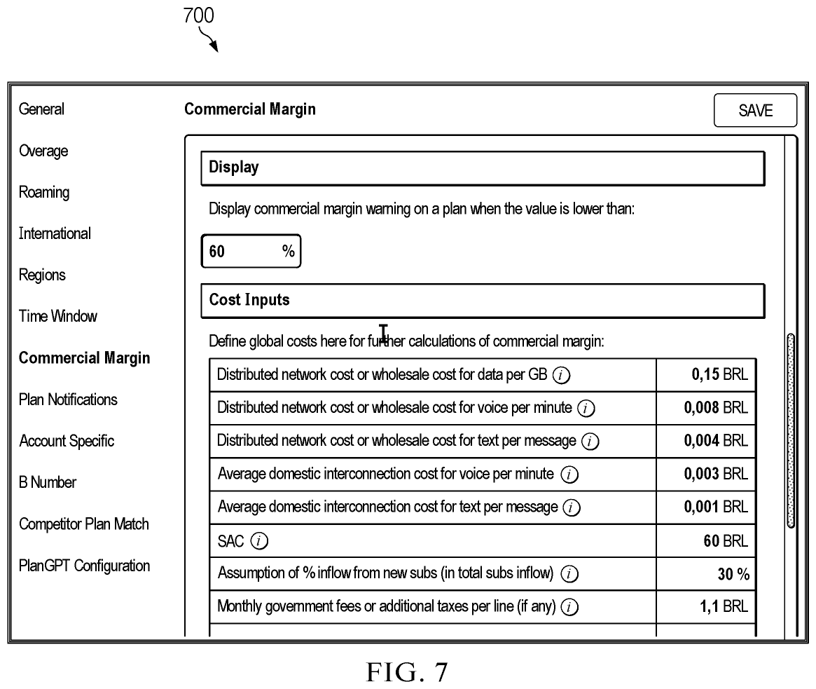

FIG. 7 depicts configuration of commercial margins in Brazilian Real currency that sets price information for calculation of prices from generated metadata 114.

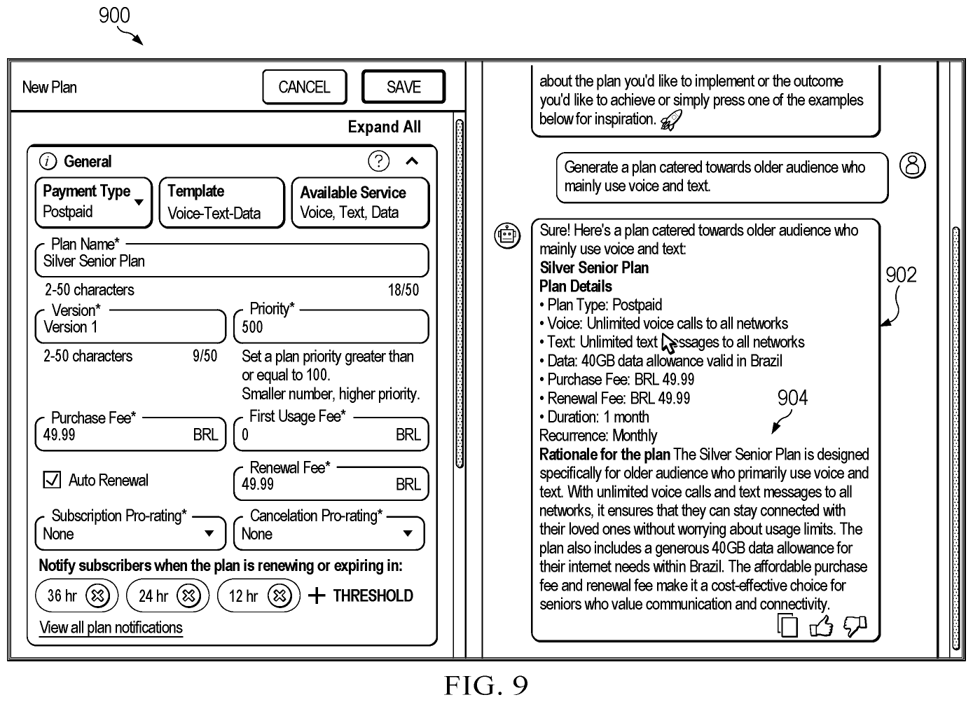

FIGS. 9-19 depict user interface plan information displays for new plans on the left side of the UI's 900-1900, and PlanGPT generated plan data, plan data explanatory rationales, prompts to provide missing information, and marketing information.

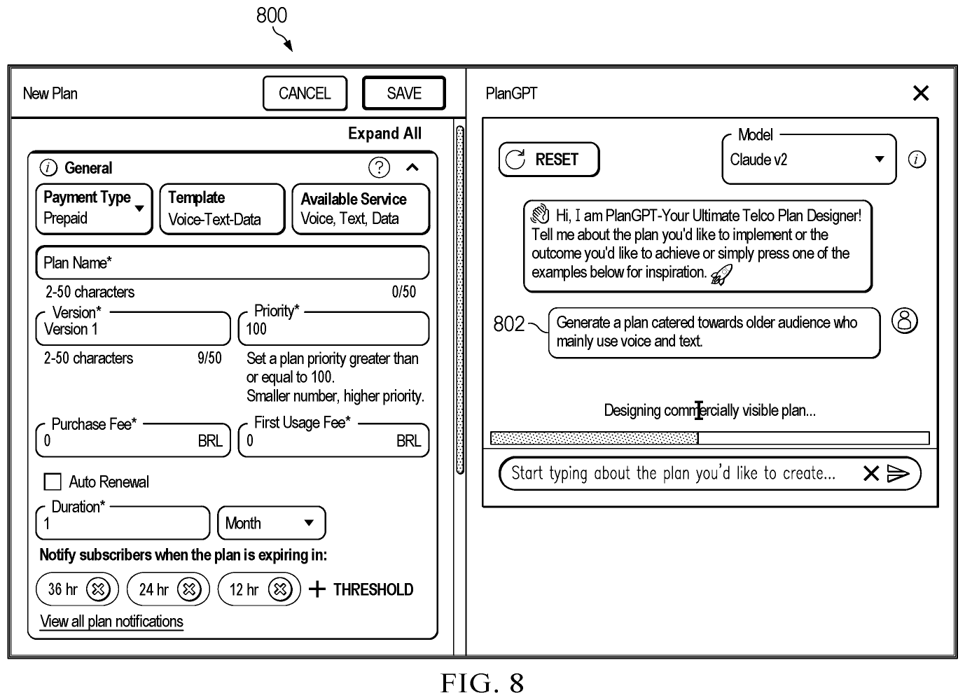

FIG. 8 depicts a new telco plan generation initialization display 800. The PlanGPT provided data includes a control window 802 that activates the AI LP 108 to initiate generation of proposed telco plan 116.

FIG. 9 depicts a generated telco planner UI display 900 that includes the proposed telco plan 902 and an AI NLP generated rationale 904 for the features, feature subtypes, and allowance values in the Silver Senior telco plan.

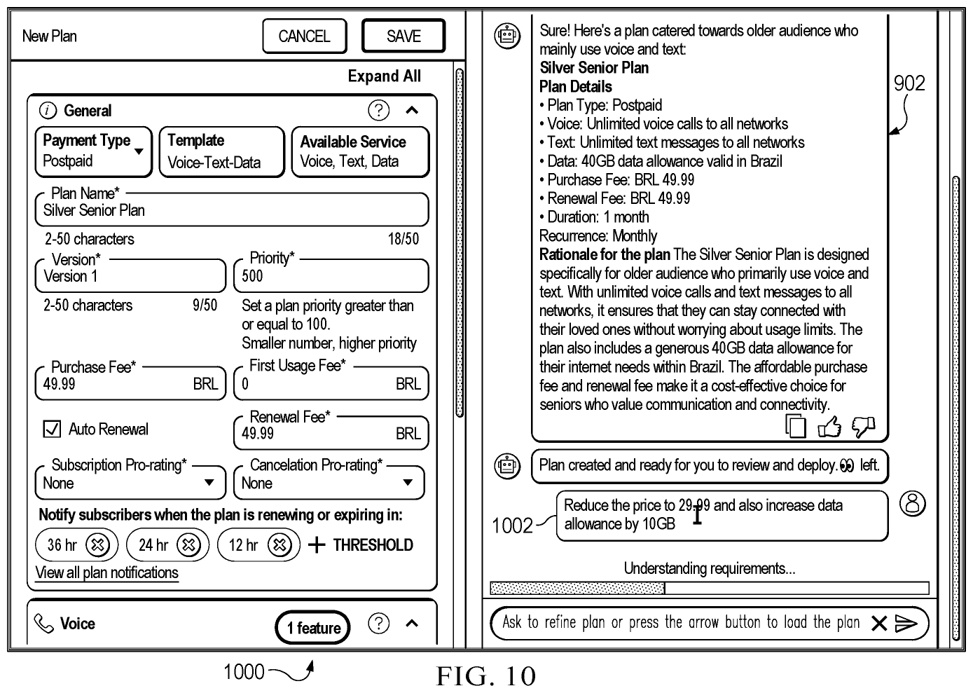

FIG. 10 depicts a generated telco planner UI display 1000 that includes the proposed telco plan 902 and a control window 1002 that activates the NL processor 110 or the AI LP 108 Plan GPT embodiment to interpret the natural language input and cause the PlanGPT to generate a telco plan 116 with a reduced price and increase in the data allowance. In at least one embodiment, the AI NLP 108 will perform the feature iteration process included in operation 212 to adjust other telco plan 116 values to correlate with the price reduction and data allowance increase.

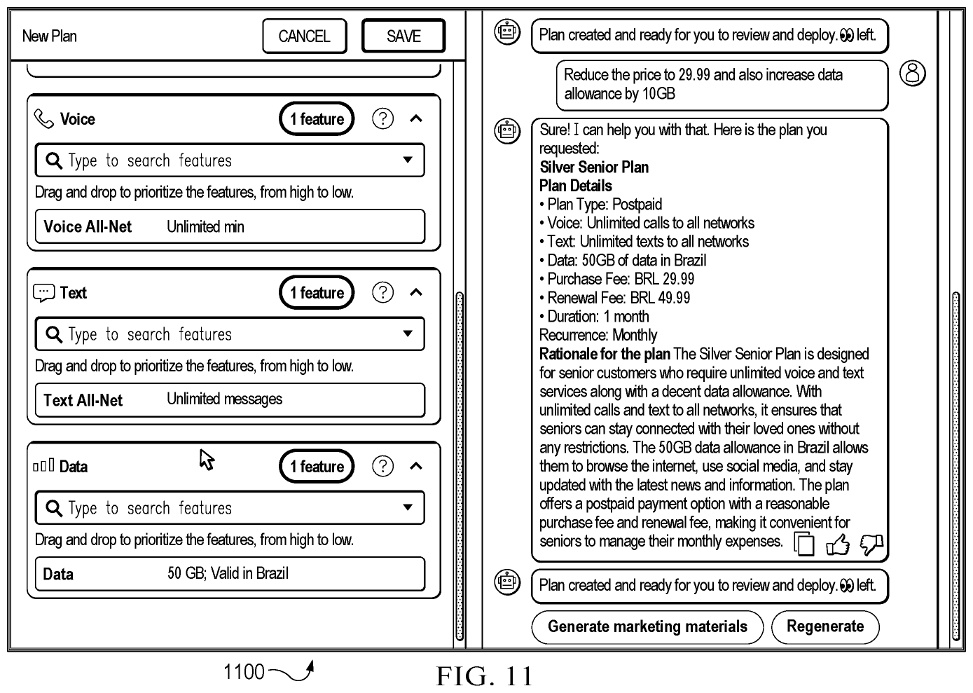

FIG. 11 depicts a generated telco planner UI display 1100 reflecting a revised telco plan 116 including a rationale for the plan after activating the AI LP 108 to generate a telco plan 116 with a price reduction and data allowance increase.

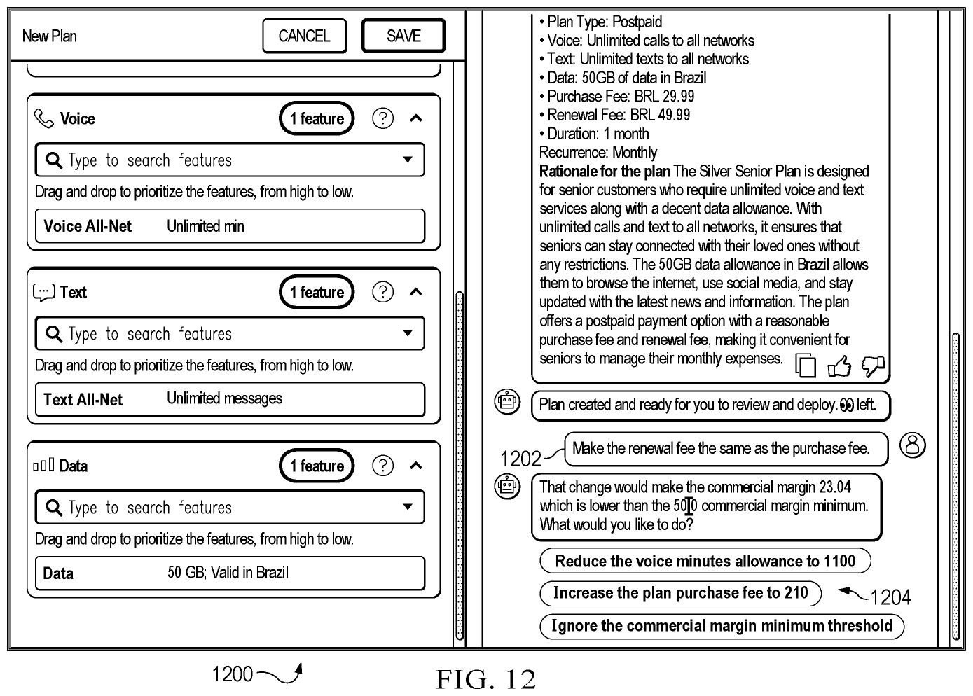

FIG. 12 depicts a generated telco planner UI display 1200 and a control window 1202 to activate the AI NLP 108 to regenerate the telco plan 116 to make the renewal fee equal the purchase fee and with options to regenerate the telco plan in accordance with telco planner plan alterations presented in accordance with activation windows 1204.

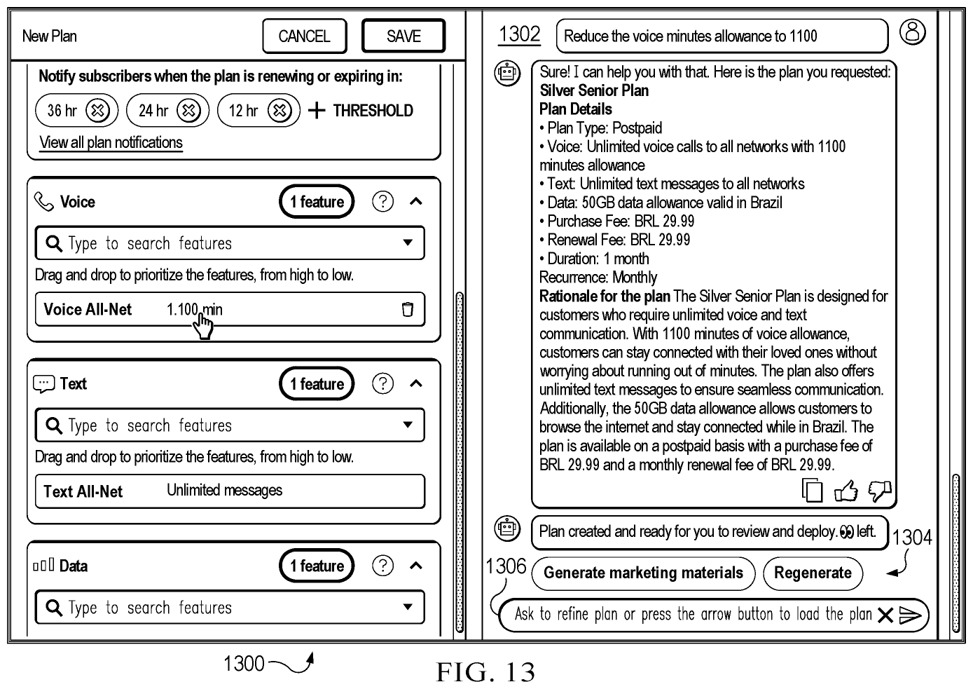

FIG. 13 depicts a generated telco planner UI display 1300 and a control window 1302 to activate the AI NLP 108 to regenerate the telco plan 116 to reduce voice minute allowance to 1100, activation buttons 1304 to generate marketing materials and cause the AI NLP 108 to regenerate the telco plan 116, and a natural language input control window 1306 to refine the telco plan 116 in accordance with a natural language telco planner input.

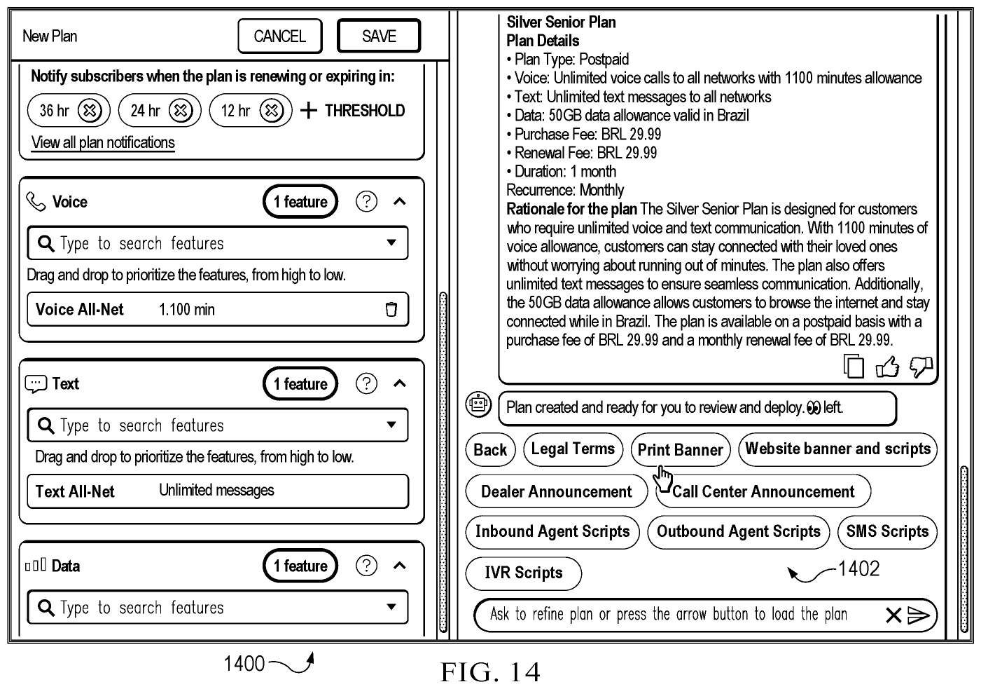

FIG. 14 depicts a generated telco planner UI display 1400 having activation buttons 1402 to generate marketing information and other telco plan announcements.

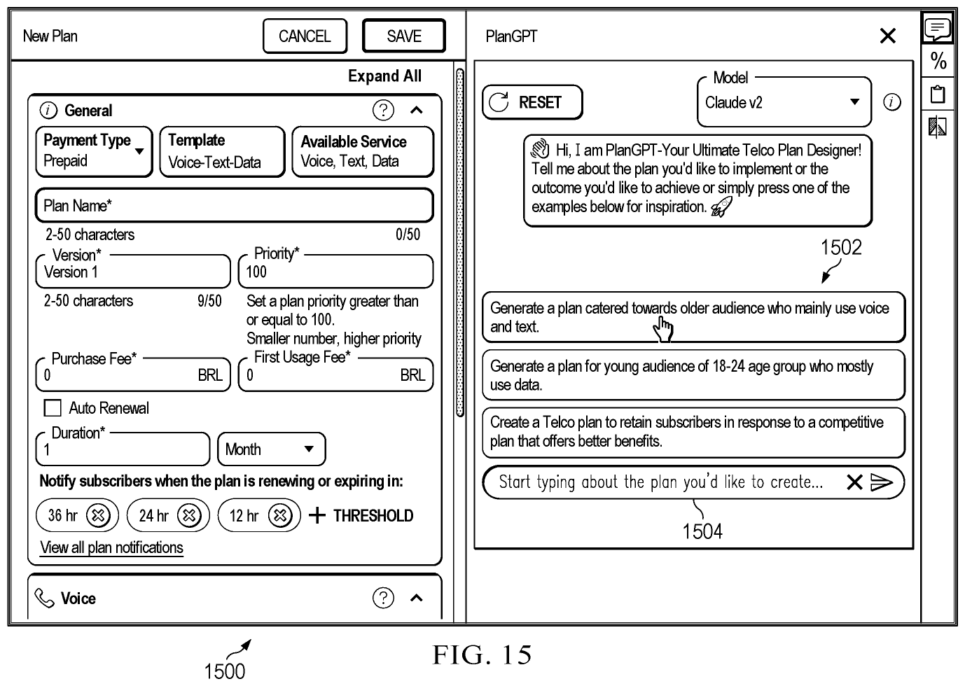

FIG. 15 depicts a generated telco planner UI display 1500 having activation buttons 1502 that present three pre-defined telco plan requests to activate PlanGPT to generate a commensurate telco plan 116. The display 1500 also includes use a natural language input window 1504 to allow a telco planner to specify a telco plan request 105 using natural language.

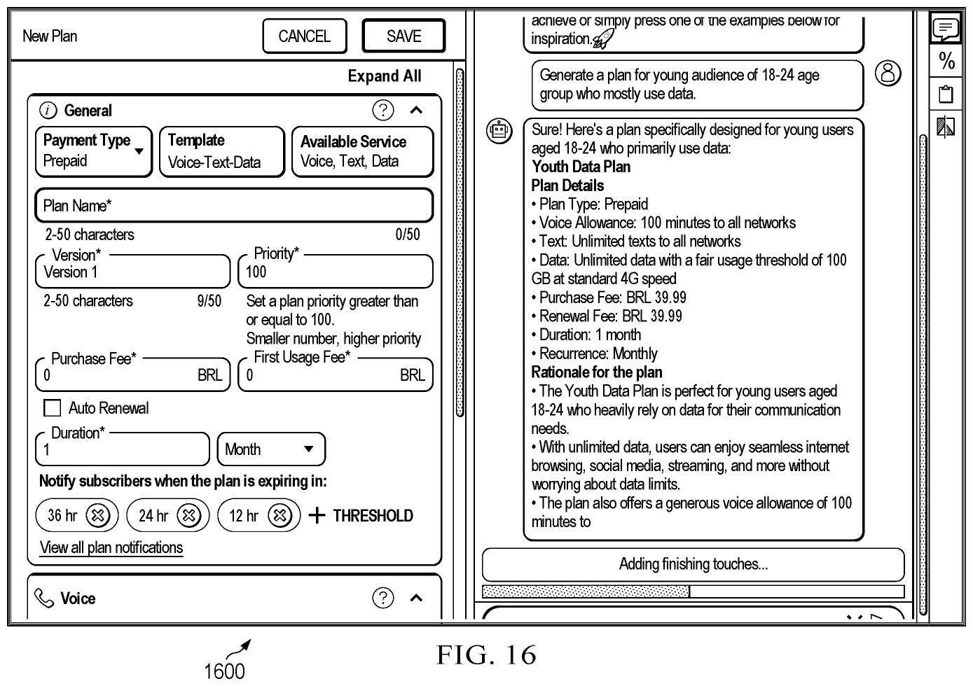

FIG. 16 depicts a generated telco planner UI display 1600 presenting a telco plan 116 generated after selecting a pre-defined plan request of “Generate a plan for young audience of 18-24 age group who mostly use data.”

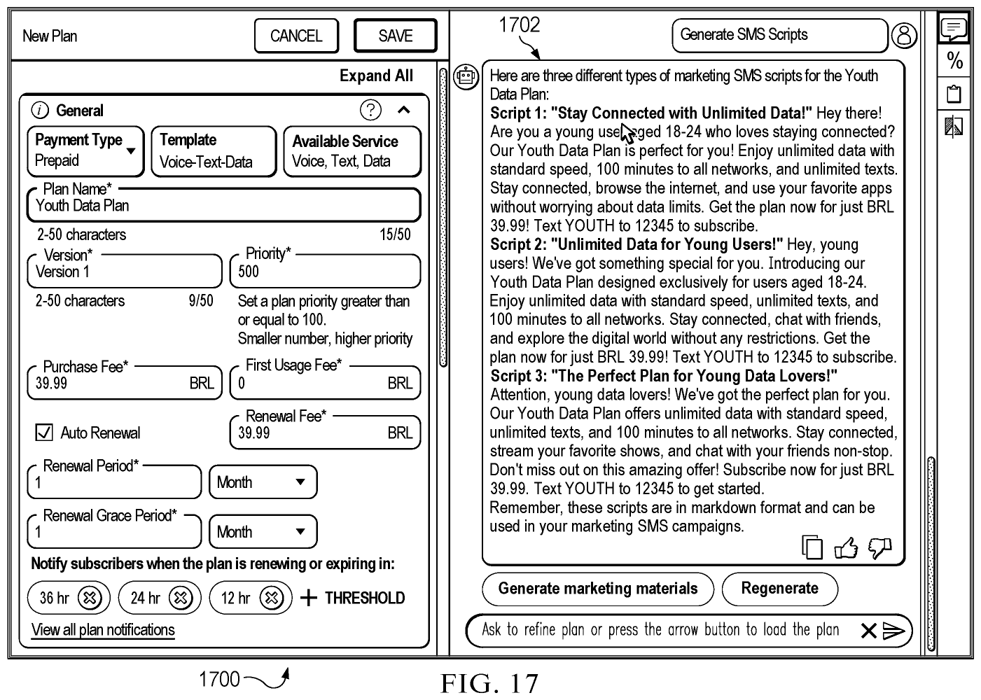

FIG. 17 depicts a generated telco planner UI display 1700 that includes AI NLP 108 generated marketing SMS scripts to promote the plan of FIG. 16 that are produced by the AI NLP 108 by selecting the activation button 1702 to generate SMS scripts.

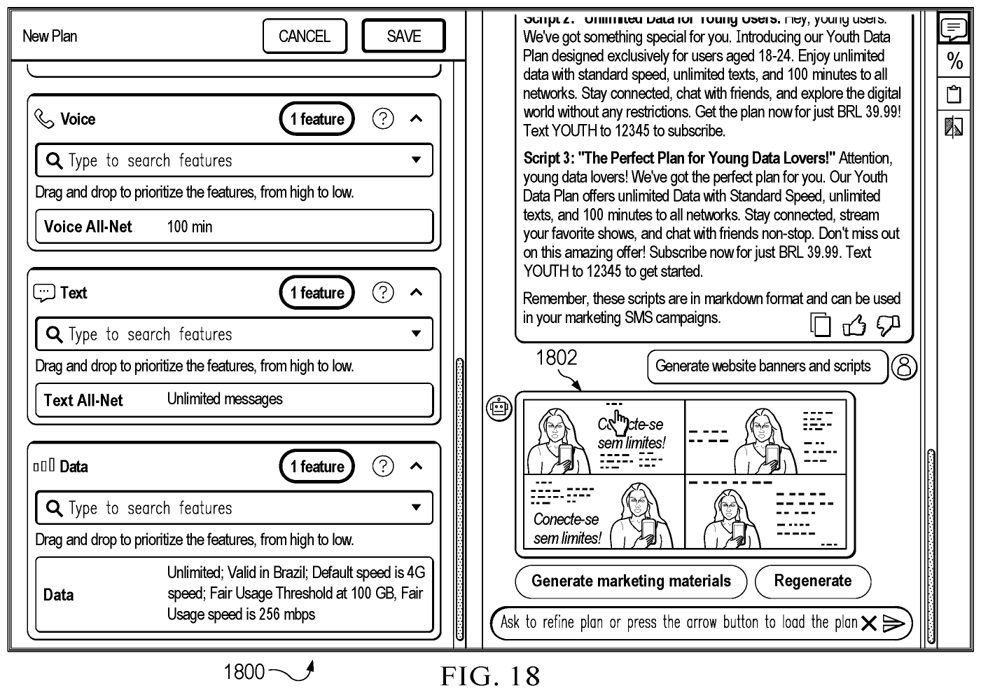

FIG. 18 depicts a generated telco planner UI display 1800 that includes the marketing SMS scripts of FIG. 17 and AI generated marketing images 1802 by AI NLP 108. In at least one embodiment, the marketing information is generated in accordance with the following process:
1. NL Processor 110 generates metadata 110 for the banner to include a Slogan, Price & Benefits.
2. The telco planner uses the integrated UI 102 to configure the banner settings as, for example, depicted in FIGS. 5 and 6.
3. The AI NLP 108 creates the AI generated image based on configuration setting via the program Replicate text-to-image generation using a stable diffusion XL (SDXL) model available from Stability.ai.
4. The background from the AI Generated image to blend the image with the background of the banner template using a Python library tool available via Githup.com.
5. The AI NLP 108 sends metadata along to the Creatomate.com web service to create the banners and send the output image uniform resource locators (URLs) to the telco client monetization platform and/or other designated recipients.

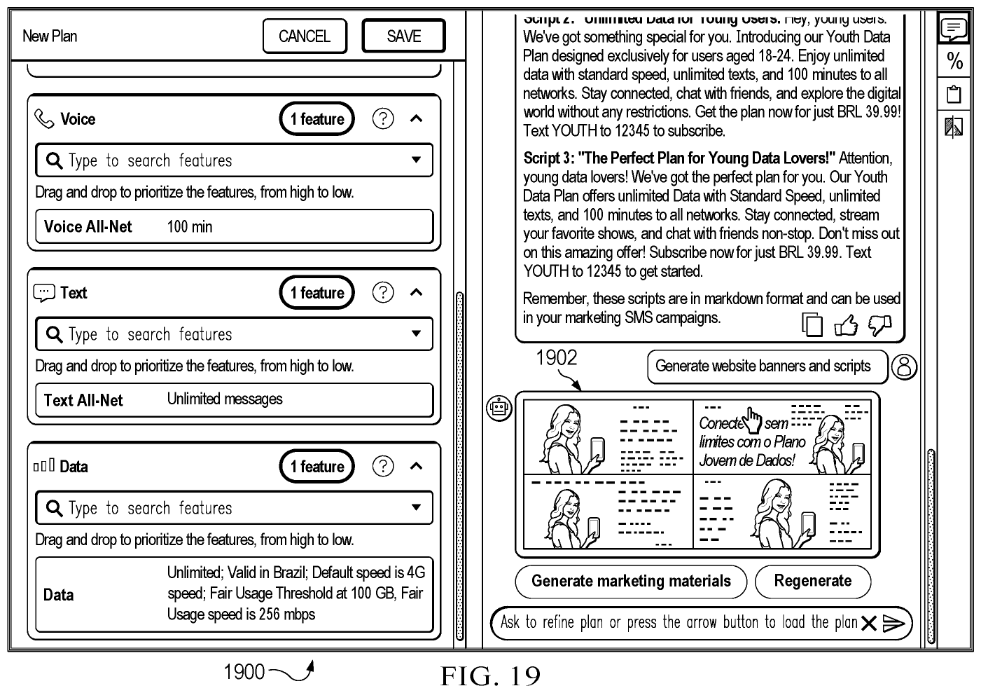

FIG. 19 depicts a generated telco planner UI display 1900 that includes the marketing SMS scripts of FIG. 17 and new AI generated marketing images 1902 by AI NLP 108. In at least one embodiment, the images are created in the same manner as images 1802 (FIG. 18).

Referring to FIG. 1, in at least one embodiment, the AI NLP 108 generates prompts for display by the integrated UI 102 that guide a telco planner using the telco client monetization platform 104 to provide missing data, instructions, telco plan configuration details, telco plan features, feature subtypes, allowances, and priority modifications, and other information useful by the AI NLP 108 to operate and generate telco plan 116. Following are exemplary instructions for generating metadata prompts:
system_msg=f″″″You are PlanGPT, a Telco Marketer and Telco Expert responsible for generating telco plans based on the user requirements. The user will provide plan description to build a Telco plan. Your task is to generate metadata for creating the Telco plan. There are 2 minimum conditions required to build the plan-business objective (market expansion, retention, competitive response, revenue growth) and target audience (youngsters, older audience, professionals, etc). Try to infer the target audience, business objective and other possible details that could be helpful to create the Telco plan metadata. Decide the case from the below 2 cases and output accordingly.
Case 1: If you cannot infer the target audience and business objective from the user's input, ask the user to provide details for these 2 things. Any other additional info could be helpful but not required and therefore don't ask for anything else apart from these 2 things from the user.
[Output format for case 1]://output should be a questions asking the user to provide more details which can help in inferring the minimum conditions required to generate the plan metadata.
Case 2: If you can infer the minimum conditions from the user input, i.e, the business objective and target audience, you need to output JSON with the following format and generate reasonable values based on business objective and target audience provided by the user:
1. category: str//business objective of the plan. (It should take a value from the following only-market_expansion, competitive_response, retention, revenue_growth)
2. target_audience: str//target audience for the plan. (It should take a value from the following only-house wifes, retired, elder_people, disabled, youngsters, professionals, white_collar)
3. content_types: List [str]//data services required by this type of target_audience. (It should select values from the following only—{content_types if content_types is not None else ‘N/A’}
4. plan_details:
a. plan_name: str//a catchy plan name based on the user query between 2-50 characters.
b. payment_type: str//the payment type for the plan. (It should take a value from the following only-prepaid, postpaid)
c. purchase_fee: float upto 2 decimals//purchase fee for this plan in (currency)
d. renewal_fee: float upto 2 decimals//renewal fee for this plan in {currency}
5. features://each feature below takes a value defining the importance of that feature for the target audience. (It should take a value from the following when the type is string-low, medium, high and from following when the type is bool-true, false
a. voice-on-net: str
b. voice-off-net: str
c. voice-all-net: str
d. voice-multi-country: str
e. voice-roaming: bool
f. voice-international: bool
g. voice-family-and-friends: str
h. text-on-net: str
i. text-off-net: str
j. text-all-net: str
k. text-multi-country: str
l. text-roaming: bool
m. text-international: bool
n. text-family-and-friends: str
o. data: str
p. data-roaming: bool
[Output format for case 1]: output should include JSON only as per above format without any greetings or acknowledging messages.″″″
user_msg=f″″″{user_query}″″″

Following are exemplary instructions for generating telco plan generation prompts:
system_msg=f″″″You are PlanGPT, a Telco Marketer and Telco Expert responsible for generating telco plans based on the user requirements. The user will provide you with a query to build Telco plan along with the Telco plan in JSON format. Follow the output format while generating the plan using the provided plan json as reference for the values. Additionally you are also provided metadata to consider when generating plans. If a particular feature has unlimited property as true, then output it as an Unlimited feature instead of giving numerical value. Ignore any questions outside the domain of Telco Plans generation. Avoid repeating yourself and keep the details crisp and to-the-point. Output in markdown format.

### [Available Metadata]:

1. Home Country: {country}
2. Currency to generate plans in: {currency}

### [Output Format]:

One line for greetings/acknowledgement of user query
**Plan Name**
**Plan Details**//Plan Details should include the plan type-prepaid or postpaid, benefits-voice, text, data, purchase fee, renewal fee, etc.
** Additional Plan Benefits**
** Rationale for the plan**″″″
user msg=f″″″{user_query}\n{generated json}″″″

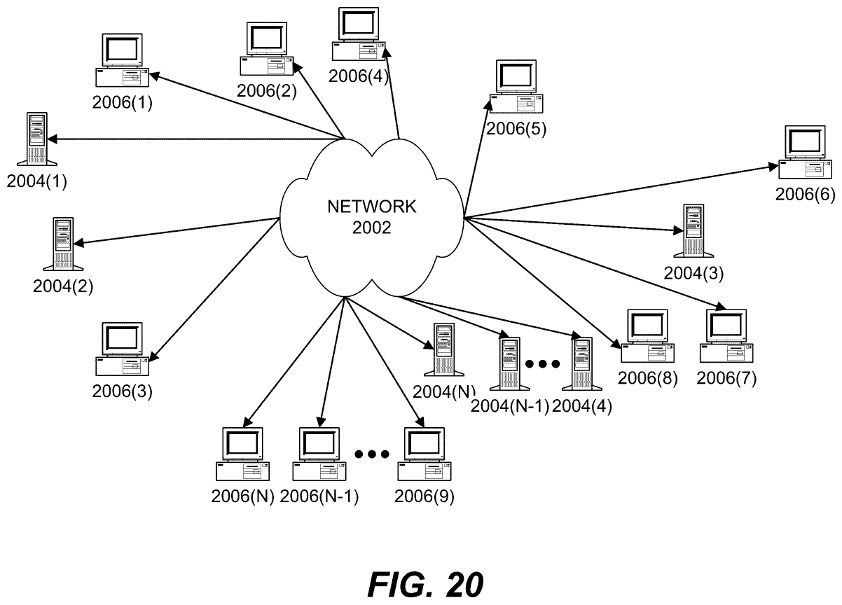

FIG. 20 is a block diagram illustrating a network environment in which an AI NLP telco plan generation environment 100 and process 200 may be practiced. Network 2002 (e.g. a private wide area network (WAN) or the Internet) includes a number of networked server computer systems 2004(1)-(N) that are accessible by client computer systems 2006(1)-(N), where N is the number of server computer systems connected to the network. Communication between client computer systems 2006(1)-(N) and server computer systems 2004(1)-(N) typically occurs over a network, such as the Internet or local network. Client computer systems 2006(1)-(N) typically access server computer systems 2004(1)-(N) through a service provider, such as an internet service provider (ISP) by executing telco planner client computer system specific software, commonly referred to as a browser, on one of client computer systems 2006(1)-(N).

Client computer systems 2006(1)-(N) and/or server computer systems 2004(1)-(N) are specialized computer programmed to improve conventional computer systems to utilize the AI NLP telco plan generation system 100 and process 200 to replace, for example, human intuition and experience, with data and technology driven processes that can communicate using natural language, determine the intent of natural language input data, and determine optimal telco plans that are objectively superior to competitive telco plans. The client computer systems 2006(1)-(N) and server computer systems 2004(1)-(N) can be specially implemented on computing devices such as server, personal, and mobile computing devices. When programmed to implement at least one embodiment of the AI NLP telco plan generation environment 100 and process 200, the computer systems are specialized machines. Such a computer system may also include one or a plurality of input/output (I/O) devices coupled to the system processor to perform specialized functions. Tangible, non-transitory memories (also referred to as “storage devices) such as hard disks, compact disk (CD) drives, digital versatile disk (DVD) drives, and magneto-optical drives may also be provided, either as an integrated or peripheral device. In at least one embodiment, the AI NLP telco plan generation environment 100 and process 200 can be implemented using code stored in a tangible, non-transient computer readable medium and executed by one or more processors. In at least one embodiment, the AI NLP telco plan generation environment 100 and process 200 can be implemented completely in hardware using, for example, logic circuits and other circuits including field programmable gate arrays.

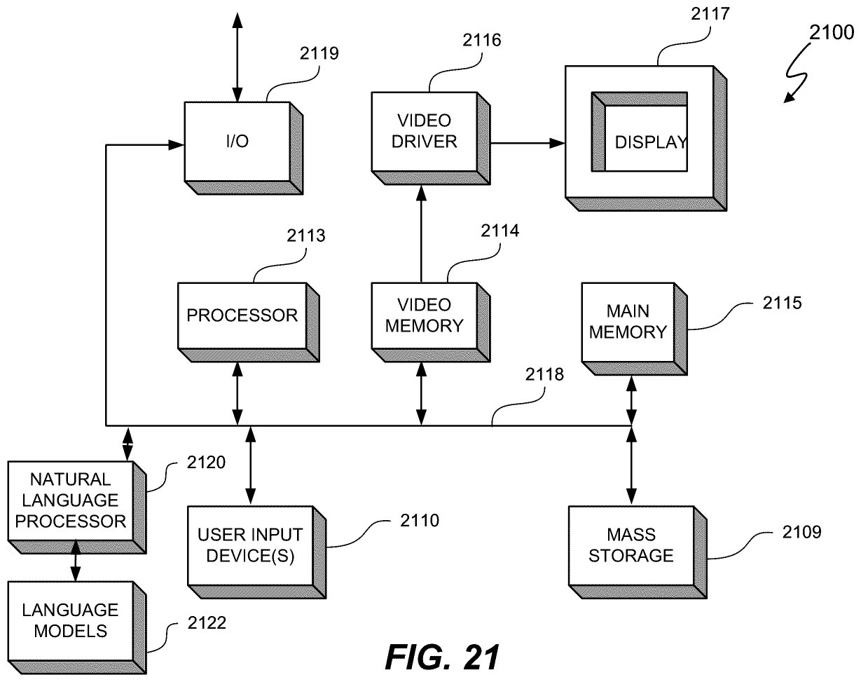

Embodiments of the AI NLP telco plan generation environment 100 and process 200 can be implemented on a computer system such as special-purpose, special programmed computer 2100 illustrated in FIG. 21. The computer 2100 can be a dedicated computer system or a virtual, emulated system located in, for example, a cloud computing environment. Input user device(s) 2110, such as a keyboard and/or mouse, are coupled to a bi-directional system bus 2118. The input user device(s) 2110 are for introducing user input to the computer system and communicating that user input to processor 2113. The computer system of FIG. 21 generally also includes a non-transitory video memory 2114, non-transitory main memory 2115, and non-transitory mass storage 2109, all coupled to bi-directional system bus 2118 along with input user device(s) 2110 and processor 2113. The mass storage 2109 may include both fixed and removable media, such as a hard drive, one or more CDs or DVDs, solid state memory including flash memory, and other available mass storage technology. Bus 2118 may contain, for example, 32 of 64 address lines for addressing video memory 2114 or main memory 2115. The system bus 2118 also includes, for example, an n-bit data bus for transferring DATA between and among the components, such as CPU 2109, main memory 2115, video memory 2114 and mass storage 2109, where “n” is, for example, 32 or 64. Alternatively, multiplex data/address lines may be used instead of separate data and address lines.

I/O device(s) 2119 may provide connections to peripheral devices, such as a printer, and may also provide a direct connection to a remote server computer systems via a telephone link or to the Internet via an ISP. I/O device(s) 2119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as instructions and data in a non-transient computer readable medium such as a flash memory, optical memory, magnetic memory, compact disks, digital versatile disks, and any other type of memory. The computer program is loaded from a memory, such as mass storage 2109, into main memory 2115 for execution. Computer programs may also be in the form of electronic signals modulated in accordance with the computer program and data communication technology when transferred via a network. Web pages are, in at least one embodiment, created using hypertext markup language or other language compatible with one or more types of web browsers. In at least one embodiment, Java applets or any other technology is used with web pages to allow a user of a web browser to make and submit selections and allow a client computer system to capture the user selection and submit the selection data to a server computer system.

The processor 2113 can be a single processor or one or more processors and, in one embodiment, is/are a microprocessor(s) manufactured by Motorola Inc. of Illinois, Intel Corporation of California, Advanced Micro Devices of California. However, any other suitable single or multiple microprocessors or microcomputers may be utilized. Main memory 2115 is comprised of dynamic random access memory (DRAM). Video memory 2114 is a dual-ported video random access memory. One port of the video memory 2114 is coupled to video amplifier 2116. The video amplifier 2116 is used to drive the display 2117. Video amplifier 2116 is well known in the art and may be implemented by any suitable means. This circuitry converts pixel DATA stored in video memory 2114 to a raster signal suitable for use by display 2117. Display 2117 is a type of monitor suitable for displaying graphic images.

The natural language processor 2120 is a form of artificial intelligence (AI) that humans and computers to interact using human language. NLP processes enable computers to analyze, understand, and respond to humans using our natural communication types, such as speech and written text. The language model 2122 is language model and includes a large language model (LLM) such as the GPT LLM. The language model 2122 is a probabilistic model of a natural language that can generate probabilities of a series of words, based on text corpora in one or multiple languages trained on and includes machine learning to improve natural language performance.

The computer system described above is for purposes of example only. The [name of system and/or process] may be implemented in any type of computer system or programming or processing environment. It is contemplated that the AI NLP telco plan generation environment 100 and process 200 might be run on a stand-alone computer system, such as the one described above. The AI NLP telco plan generation environment 100 and process 200 might also be run from a server computer systems system that can be accessed by a plurality of client computer systems interconnected over an intranet network. Finally, the AI NLP telco plan generation environment 100 and process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method comprising:
providing a user interface to integrate communication between a telco planner client computer system and an artificial intelligence (AI) natural language processor (NLP) and telco plan generation system (AI NLP telco plan generation system) to:
(i) receive a natural language telco plan request; and
(ii) transmit to the AI NLP telco plan generation system, wherein the AI NLP telco plan generation system includes an artificial intelligence system having a natural language processing engine that includes a language model and machine learning algorithms;
receiving, with the AI NLP telco plan generation system via the user interface, the natural language telco plan request framework data from the telco planner client computer system, wherein the natural language telco plan data includes data describing a telco plan desired by a user of the telco planner client computer system; and
activating the AI NLP telco plan generation system to perform operations comprising:
a. determining and organizing metadata from the natural language telco plan data into a format that determines an intent of the machine-perceived user-intended telco plan, wherein the machine perceived user intended telco plan includes first telco plan features;
b. matching features of existing telco plans to the first telco plan features to identify competitive telco plans; and
c. generating a proposed telco plan consistent with the machine perceived user intended telco plan having features and feature values that exceed the competitive telco plan features and feature values within defined constraints.

2. The method of claim 1 wherein providing an integrated AI NLP telco plan generation system interface between the telco planner client computer system and an AI NLP telco plan generation system to receive a natural language telco plan request comprises:
providing the integrated AI NLP telco plan generation system interface to present a user interface that includes telco plan suggestions.

3. The method of claim 1 wherein determining the machine-perceived user intended telco plan comprises:
parsing the organized metadata from the natural language telco plan data;
from the parsing, identifying the features and feature subtypes in the natural language telco plan data; and
correlating the identified features and feature subtypes with user intent to determine the machine-perceived user intended telco plan.

4. The method of claim 1 wherein the format is a JavaScript Object Notation (JSON) format.

5. The method of claim 1 further comprising:
determining if the user telco request includes sufficient information to determine the user intent for the desired customer telco plan; and
if the user telco request is sufficient to determine the user intent for the desired customer telco plan, providing feedback to the user to provide additional information needed by the AI NLP telco plan generation system to determine the user intent.

6. The method of claim 1 wherein generating the proposed telco plan consistent with the machine perceived user intended telco plan having features and feature values that exceed the competitive telco plan features and feature values within user-defined constraints comprises:
based on the organized metadata, initializing a telco plan with an empty list of features;
iterating over all the additional telco plans; and
for each feature subtype, creating a list of all unique features sorted in ascending order of value from a first to last element in accordance with a predetermined measure of value;
creating a max feature telco plan with features of the telco plan having maximum allowance values, which is the last element for each feature subtype; and
revising the allowances values to meet predetermined telco plan constraints.

7. The method of claim 6 wherein revising the allowances values for each feature to meet predetermined telco plan constraints comprises:
prioritizing features; and
adjusting allowance values of features in order of ascending feature priority from low priority to highest priority.

8. The method of claim 1 wherein revising the allowances values for each feature to meet predetermined telco plan constraints comprises:
generating marketing information for the generated proposed telco plan, wherein generating the marketing information comprises:
activating the AI NLP telco plan generation system to utilize the generated proposed telco plan to generate marketing metadata for the marketing information;
access pre-configured marketing information settings;
providing the marketing information to a text-to-image generative artificial intelligence (AI) system to generate an image based on the marketing information;
removing background information from the AI generated image to blend the image with a background of a template for the marketing information;
sending all the metadata to a video automater to generate video marketing information; and
send the output image uniform resource locators to one or more computer systems.

9. The method of claim 8 wherein revising the allowances values for each feature to meet predetermined telco plan constraints comprises:
providing the marketing information and a stable diffusion XL image generation model to the text-to-image generative artificial intelligence system to generate an image advertising the marketing information.

10. The method of claim 8 further comprising:
blending the image with a background of a template using a python library.

11. The method of claim 1 further comprising:
providing prompts to a user to solicit and collect information to generate the telco plan and the marketing information.

12. The method of claim 1 further comprising:
repeating the activated AI NLP telco plan generation system operations a, b, and c and performing operations comprising:
generating at least one additional proposed telco plan consistent with the machine perceived user intended telco plan with each additional proposed telco plan having at least one unique feature or feature value or at least one unique feature and feature value.

13. The method of claim 1 wherein the natural language telco plan request framework includes sufficient information for the AI NLP telco plan generation system to determine a business objective, a target segment, identification of one or more competitor plans, and telco plan features and feature values.

14. An apparatus comprising:
one or more processors; and
a memory, coupled to the one or more processors, that includes code that when executed causes the one or more processors to perform operations comprising:
providing a user interface to integrate communication between a telco planner client computer system and an artificial intelligence (AI) natural language processor (NLP) and telco plan generation system (AI NLP telco plan generation system) to:
(i) receive a natural language telco plan request; and
(ii) transmit to the AI NLP telco plan generation system, wherein the AI NLP telco plan generation system includes an artificial intelligence system having a natural language processing engine that includes a language model and machine learning algorithms;
receiving, with the AI NLP telco plan generation system via the user interface, the natural language telco plan request framework data from the telco planner client computer system, wherein the natural language telco plan data includes data describing a telco plan desired by a user of the telco planner client computer system;
activating the AI NLP telco plan generation system to perform operations comprising:
a. determining and organizing metadata from the natural language telco plan data into a format that determines an intent of the machine-perceived user-intended telco plan, wherein the machine perceived user intended telco plan includes first telco plan features;
b. matching features of existing telco plans to the first telco plan features to identify competitive telco plans; and
c. generating a proposed telco plan consistent with the machine perceived user intended telco plan having features and feature values that exceed the competitive telco plan features and feature values within defined constraints.

15. The apparatus of claim 14 wherein providing an integrated AI NLP telco plan generation system interface between the telco planner client computer system and an AI NLP telco plan generation system to receive a natural language telco plan request comprises:
providing the integrated AI NLP telco plan generation system interface to present a user interface that includes telco plan suggestions.

16. The apparatus of claim 14 wherein determining the machine-perceived user intended telco plan comprises:
parsing the organized metadata from the natural language telco plan data;
from the parsing, identifying the features and feature subtypes in the natural language telco plan data; and
correlating the identified features and feature subtypes with user intent to determine the machine-perceived user intended telco plan.

17. The apparatus of claim 14 wherein the format is a JavaScript Object Notation (JSON) format.

18. The apparatus of claim 14 wherein when the code is executed the code causes the one or more processor to perform further operations comprising:
determining if the user telco request includes sufficient information to determine the user intent for the desired customer telco plan; and
if the user telco request is sufficient to determine the user intent for the desired customer telco plan, providing feedback to the user to provide additional information needed by the AI NLP telco plan generation system to determine the user intent.

19. The apparatus of claim 14 wherein generating the proposed telco plan consistent with the machine perceived user intended telco plan having features and feature values that exceed the competitive telco plan features and feature values within user-defined constraints comprises:
based on the organized metadata, initializing a telco plan with an empty list of features;
iterating over all the additional telco plans; and
for each feature subtype, creating a list of all unique features sorted in ascending order of value from a first to last element in accordance with a predetermined measure of value;
creating a max feature telco plan with features of the telco plan having maximum allowance values, which is the last element for each feature subtype; and
revising the allowances values to meet predetermined telco plan constraints.

20. The apparatus of claim 19 wherein revising the allowances values for each feature to meet predetermined telco plan constraints comprises:
prioritizing features; and
adjusting allowance values of features in order of ascending feature priority from low priority to highest priority.

21. The apparatus of claim 14 wherein revising the allowances values for each feature to meet predetermined telco plan constraints comprises:
generating marketing information for the generated proposed telco plan, wherein generating the marketing information comprises:
activating the AI NLP telco plan generation system to utilize the generated proposed telco plan to generate marketing metadata for the marketing information;
access pre-configured marketing information settings;
providing the marketing information to a text-to-image generative artificial intelligence (AI) system to generate an image based on the marketing information;
removing background information from the AI generated image to blend the image with a background of a template for the marketing information;
sending all the metadata to a video automater to generate video marketing information; and
send the output image uniform resource locators to one or more computer systems.

22. The apparatus of claim 21 wherein revising the allowances values for each feature to meet predetermined telco plan constraints comprises:
providing the marketing information and a stable diffusion XL image generation model to the text-to-image generative artificial intelligence system to generate an image advertising the marketing information.

23. The apparatus of claim 21 wherein when the code is executed the code causes the one or more processor to perform further operations comprising:
blending the image with a background of a template using a python library.

24. The apparatus of claim 14 wherein when the code is executed the code causes the one or more processor to perform further operations comprising:
providing prompts to a user to solicit and collect information to generate the telco plan and the marketing information.

25. The apparatus of claim 14 wherein when the code is executed the code causes the one or more processor to perform further operations comprising:
repeating the activated AI NLP telco plan generation system operations a, b, and c and performing operations comprising:
generating at least one additional proposed telco plan consistent with the machine perceived user intended telco plan with each additional proposed telco plan having at least one unique feature or feature value or at least one unique feature and feature value.

26. The apparatus of claim 14 wherein the natural language telco plan request framework includes sufficient information for the AI NLP telco plan generation system to determine a business objective, a target segment, identification of one or more competitor plans, and telco plan features and feature values.
